(19) United States
(12) Patent Application Publication
(10) Pub. No.: US 2026/0316914 A1
(43) Pub. Date: Oct. 15, 2026

(54) HYDRAULIC SYSTEM, METHOD FOR OPERATING A HYDRAULIC SYSTEM, AND HYDRAULIC UNIT

(71) Applicant: HAWE Hydraulik SE, Aschheim (DE)

(72) Inventors: Florian Mayr, Aschheim (DE); Paul Franz, Aschheim (DE); Jürgen Osterried, Aschheim (DE)

(73) Assignee: HAWE Hydraulik SE, Aschheim (DE)

(21) Appl. No.: 19/463,752

(22) Filed: Jan. 29, 2026

(30) Foreign Application Priority Data
Jan. 31, 2025 (DE) 10 2025 103 672.1

(51) Int. Cl. B63H 20/10; B63H 25/02; F15B 13/02; F15B 15/18

(52) U.S. Cl. CPC B63H 20/106; B63H 25/02; F15B 13/027; F15B 15/18

(57) ABSTRACT

A hydraulic system with a pump, a motor, a first line arrangement, and a second line arrangement is disclosed. The first line arrangement is connected to the pump and a first consumer connection. The second line arrangement is connected to the pump and a second consumer connection. A first check valve is disposed in the first line arrangement. A second check valve is disposed in the second line arrangement. The motor drives the pump in a first direction of rotation in the first pressurization mode to pressurize the first line arrangement and in a second direction of rotation in the second pressurization mode to pressurize the second line arrangement. The invention also relates to a hydraulic unit with a hydraulic system and a method for operating the hydraulic system.

### CROSS-REFERENCE TO RELATED APPLICATION

This application claims priority from German Application No. DE 10 2025 103 672.1 filed Jan. 31, 2025, the entire content of which is incorporated herein by reference.

### FIELD

The present disclosure relates to a hydraulic system, a method for operating such a hydraulic system, and a hydraulic unit with such a hydraulic system. The hydraulic unit is intended for maritime use and is configured in particular as a unit for trimming, tilting, and/or steering a boat drive.

### BACKGROUND

Hydraulic systems usually comprise a pump and a tank. When the hydraulic system is used with a hydraulic unit for steering a boat motor, a steering cylinder unit is usually provided as a hydraulic consumer. The steering cylinder unit has a first piston chamber, a cylinder piston unit, and a second piston chamber separated from the first piston chamber by the cylinder piston unit. At least one piston rod is attached to the cylinder piston unit, which deflects the boat drive as desired by applying pressure to the respective piston chamber.

To pressurize the respective piston chamber, the pump is connected to the first piston chamber via a first line arrangement and a first consumer connection and to the second piston chamber via a second line arrangement and a second consumer connection. When pressure is applied to the second piston chamber, the first piston chamber is also connected to the tank via the first line arrangement, in that the first line arrangement has a first check valve that can be opened when pressure is applied to the second line arrangement. Similarly, when pressure is applied to the first piston chamber, the second piston chamber is connected to the tank via the second line arrangement, in that the second line arrangement has a second check valve that can be opened when pressure is applied to the first line arrangement.

### SUMMARY

The present disclosure therefore aims to provide a cost-effective hydraulic system with improved start-up behavior and reliable stop behavior. This problem is solved with a hydraulic system disclosed herein and a method for operating such a hydraulic system also disclosed herein. Preferable further embodiments are described in the dependent claims.

A hydraulic system is provided with a reversible pump, a motor for driving the pump, a first line arrangement, a second line arrangement, and a control unit. The first line arrangement is connected to the pump and a first consumer connection. The second line arrangement is connected to the pump and a second consumer connection. A first openable check valve is disposed in the first line arrangement and a second openable check valve is disposed in the second line arrangement. The control unit is configured to switch the motor between a first pressurization mode, a second pressurization mode, and a stop mode. The motor drives the pump in a first direction of rotation in the first pressurization mode to pressurize the first line arrangement and in a second direction of rotation in the second pressurization mode to pressurize the second line arrangement. The motor is preferably a direct current motor. The motor can be configured as a direct current brush motor or as a brushless direct current motor.

The hydraulic system according to the present disclosure is distinguished from the hydraulic systems known from the prior art in that that the control unit is configured to operate the motor in the second pressurization mode for a defined time period when switching between the first pressurization mode and the stop mode, and to operate it in the first pressurization mode for a defined time period when switching between the second pressurization mode and the stop mode. This means that the direction of flow is reversed for a certain time period each time the mode is changed. On the one hand, this leads to a reduction in hydraulic pressure and thus improved start-up behavior, and on the other hand, the hydraulic conditions when the motor is stopped are improved so that the correspondingly opened check valve closes securely. Since the motor does not have to start up against high hydraulic pressure, the motor angle can be estimated as described above, resulting in a sensor-free and therefore cost-effective and simple hydraulic system. Of course, sensors can also be used to determine the motor angle, as it is also advantageous with such a solution to relieve the pressure on the line in advance or to improve the hydraulic conditions when stopping the motor.

The first check valve is configured so that it is opened when pressure is applied to the second line arrangement, and the second check valve is configured so that it is opened when pressure is applied to the first line arrangement. This allows hydraulic fluid to flow back directly to the pump or the tank of the hydraulic system via the line arrangement that is not pressurized.

Preferably, the defined time period is at least 5 milliseconds and at most 100 milliseconds. This prevents movement of the hydraulic consumer connected to the consumer connections. It is conceivable that the defined time period is variable and is adjusted, for example, depending on external factors. External factors can be, for example, the ambient temperature, the temperature of the hydraulic fluid, or the pressure in the corresponding line arrangement.

Preferably, the control unit is configured to initially drive the motor in the second pressurization mode for the defined time period when switching from the stop mode to the first pressurization mode. In other words, the motor is preferably switched from the stop mode first to the second pressurization mode for the defined time period and then to the first pressurization mode. Preferably, the control unit is further configured to initially drive the motor in the first pressurization mode for the defined time period when switching from the stop mode to the second pressurization mode. In other words, the motor is thus preferably switched from the stop mode first to the first pressurization mode for the defined time period and then to the second pressurization mode. This causes the corresponding line arrangement to be pressurized to be relieved, as it is "emptied" before the actual pressurization. This means that the motor does not have to start up against high hydraulic pressure and a higher speed, and thus full torque, can be achieved before the actual working pressure is required.

Preferably, the control unit is configured to initially drive the motor in the second pressurization mode for the defined time period when switching from the first pressurization mode to the stop mode. In other words, it is preferable to switch from the first pressurization mode to the second pressurization mode for the defined time period and then to the stop mode. It is also preferable if the control unit is configured to initially drive the motor in the first pressurization mode for the defined time period when switching from the second pressurization mode to the stop mode. In other words, it is preferable to switch from the second pressurization mode to the first pressurization mode for the defined time period and then to the stop mode. This prevents, for example, trapped hydraulic pressure from preventing the respective opened check valve from closing safely.

In this regard, it should be noted that, for example, if a switch is desired directly from the first pressurization mode to the second pressurization mode, the delivery direction of the pump and thus also the direction of rotation of the motor must be reversed. Thus, in such a case, it is preferable to first switch to the stop mode and then to the second pressurization mode. Preferably, the sequence is as follows: the motor is first in the first pressurization mode and then the motor is switched to the second pressurization mode for the defined time period. The motor is then briefly in stop mode and is then switched to the first pressurization mode for the defined time period before the motor is switched to the second pressurization mode.

According to the present disclosure, the method for operating a hydraulic system provides that when switching between the first pressurization mode and the stop mode, the motor is driven in the second pressurization mode for a defined time period, and when switching between the second pressurization mode and the stop mode, the motor is driven in the first pressurization mode for a defined time period. This results in the aforementioned advantages.

Furthermore, the present disclosure relates to a hydraulic unit with a hydraulic system and a hydraulic consumer. The hydraulic consumer is connected to the first consumer connection and the second consumer connection. The hydraulic unit is configured in particular for maritime applications. The hydraulic unit is preferably configured as a hydraulic unit for trimming, tilting, and/or steering a boat drive. The boat drive can be, for example, an outboard motor or a Z-drive.

### BRIEF DESCRIPTION OF THE DRAWINGS

The present disclosure is explained in more detail below with reference to an exemplary embodiment shown in the figures, wherein:

FIG. 1 shows a boat with a hydraulic unit according to one or more embodiments shown and described herein;

FIG. 2 shows a hydraulic circuit diagram of a hydraulic unit with a hydraulic system according to one or more embodiments shown and described herein; and

FIG. 3 shows an exemplary flow chart for operating the hydraulic system according to one or more embodiments shown and described herein.

### DETAILED DESCRIPTION

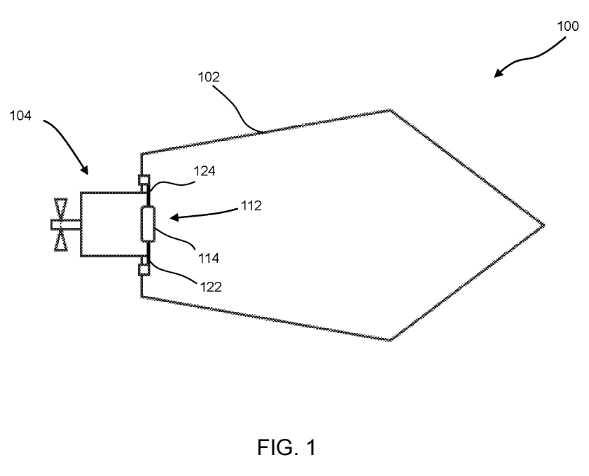

FIG. 1 shows a boat 100 with a hull 102 and a boat drive 104. In this embodiment, the boat drive 104 is configured as an outboard motor. The outboard motor 104 can be pivoted from its shown center position about an axis of rotation relative to the hull 102 to the left or right in order to steer the boat 100. For this purpose, a hydraulic unit 110 according to the present disclosure is provided, which in this embodiment is configured as a hydraulic unit 110 for steering the outboard motor 104. However, this should not be understood as restrictive, as the hydraulic unit can also be configured, for example, as a trim unit, tilt unit, or combined trim-tilt unit.

The hydraulic unit may comprise a pump. The pump may be configured as a reversible pump or 2-quadrant pump in order to selectively pressurize either the first line arrangement or the second line arrangement. For this purpose, the pump is driven by a motor, whereby the motor can be driven or controlled via a control unit between a stop mode, a first pressurization mode for pressurizing the first line arrangement, and a second pressurization mode for pressurizing the second line arrangement. Such motors can be provided as DC brush motors or as brushless DC motors, also known as BLDC motors. Due to the lower power density of DC brush motors, brushless DC motors are generally preferred.

In known solutions with brushless DC motors, it is generally necessary to know the motor angle of the rotor in order to enable smooth starting. Sensors, such as Hall sensors, can be used for this purpose to determine the motor angle before starting and thus ensure that the stator coils are supplied with the appropriate current for smooth starting. The disadvantage of this is the space required and the cost of the sensor technology.

There are therefore also sensor-free solutions in which the motor angle is derived from the motor inductance. For this purpose, short current pulses are applied, which cause a slight motor movement and thus generate a measurable current through inductance. This allows the motor angle to be estimated and, as a result, a smooth start-up with appropriate current supply to the stator coils.

Due to their design, brushless DC motors only deliver full torque above a certain speed. If the motor has to start up against high hydraulic pressure at the pump, it can reach its performance limit and start-up will be slow or impossible. At low temperatures, these problems are even exacerbated due to the increasing viscosity of the hydraulic fluid. Start-up problems therefore arise in particular with sensorless solutions, as the motor angle can only be determined by small movements.

Another problem with the aforementioned hydraulic units may be that the opened check valve does not close properly when switching to stop mode due to the hydraulic conditions.

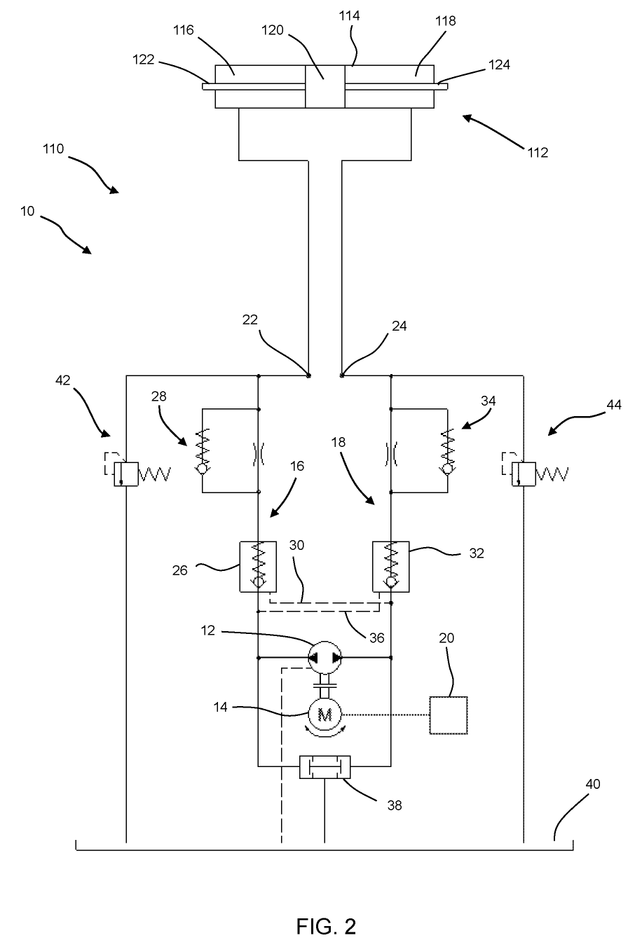

The hydraulic unit 110 according to the present disclosure comprises a steering cylinder unit 112, see also FIG. 2. The steering cylinder unit 112 is configured as a synchronous cylinder and has a cylinder housing 114 with a first piston chamber 116 and a second piston chamber 118. The first piston chamber 116 is separated from the second piston chamber 118 by a cylinder piston unit configured as a single cylinder piston 120. As can be seen in FIG. 2, the cylinder piston 120 has two piston rods 122, 124 which extend in opposite directions from the cylinder housing 114 of the steering cylinder unit 112. To pressurize the first piston chamber 116 and the second piston chamber 118 and thus to move the cylinder piston 120 (and thus to move the boat drive 101 relative to the hull of the boat 100 by means of the piston rods), the hydraulic unit 110 also comprises a hydraulic system 10 according to the present disclosure.

The hydraulic system 10 according to the present disclosure comprises a reversible pump 12, a motor 14 for driving the pump 12, a first line arrangement 16, and a second line arrangement 18. The motor 14 is configured as a brushless DC motor and is controlled by a control unit 20 of the hydraulic system 10. This is indicated in FIG. 2 by the dotted line between motor 14 and control unit 20.

The first line arrangement 16 is connected to the pump 12 and a first consumer connection 22. The second line arrangement 18 is also connected to the pump 12 and to a second consumer connection 24. As shown, the first piston chamber 116 of the steering cylinder unit 112 is connected to the first line arrangement 16 via the first consumer connection 22. Furthermore, the second piston chamber 118 of the steering cylinder unit 112 is connected to the second line arrangement 18 via the second consumer connection 24.

A first openable check valve 26 and a first throttle device 28 are disposed in the first line arrangement 16. The first check valve 26 is connected to the second line arrangement 18 via a first control line 30 in such a way that pressurization of the second line arrangement 18 hydraulically opens the first check valve 26. Accordingly, a second openable check valve 32, which is connected to the first line arrangement 16 via a second control line 36, and a second throttle device 34 are disposed in the second line arrangement 18. Consequently, the second check valve 32 is hydraulically opened when pressure is applied to the first line arrangement 16.

The pump 12 is connected to a tank 40 of the hydraulic system 10 via a pressure-controlled selector valve 38 and via the first line arrangement 16 and the second line arrangement 18. Depending on the direction of flow of the pump 12, either the first line arrangement 16 or the second line arrangement 18 can be pressurized, as will be explained in more detail below.

The first throttle device 28 and the second throttle device 34 each have a bypass line with a check valve that opens in the direction of flow toward the cylinder unit 112, as well as a throttle. With regard to the mode of operation of the throttle devices 28, 34 as flow regulators and their specific configuration, reference is made, for example, to DE 10 2021 204 032 B4, the content of which is hereby incorporated by reference in its entirety into the present disclosure.

The control unit 20 is configured to start and operate the motor 14 in a first direction of rotation in a first pressurization mode and in a second direction of rotation in a second pressurization mode. Furthermore, the control unit is configured to switch the motor 14 to a stop mode in which the motor is not operated.

In the first pressurization mode, the motor 14 rotates so that the first line arrangement 16 is pressurized via the pump 12. The first check valve 26 is opened by the pressure in the first line arrangement 16 and the first piston chamber 116 is supplied with pressure without throttling due to the first throttling device 28. The cylinder piston 120 moves relative to the cylinder housing 114 (to the right in FIG. 2), so that the first piston rod 122 retracts and the second piston rod 124 extends. At the same time, the second check valve 32 is activated by the pressure now present in the second control line 36. The cylinder piston 120 displaces hydraulic fluid from the second piston chamber 118 into the second line arrangement 18. Due to the second throttle device 34, the displaced hydraulic fluid flows out in a throttled manner to prevent the cylinder piston 120 from rushing ahead. Since the second check valve 32 is opened, the returning hydraulic fluid can be sucked back in directly via the pump 12. The pressure in the first line arrangement 16 switches the selector valve 38 so that the second line arrangement 18 is connected to the tank 40. Any difference in the volume of hydraulic fluid can thus be sucked back directly from the tank 40 via the second line arrangement 18.

In the second pressurization mode, the motor 14 rotates in the opposite direction and thus in such a way that the second line arrangement 18 is pressurized via the pump 12. The second check valve 32 is opened by the pressure in the second line arrangement 18 and the second piston chamber 118 is supplied with pressure without throttling due to the second throttling device 34. The cylinder piston 120 moves relative to the cylinder housing 114 (to the left in FIG. 2), so that the first piston rod 122 extends and the second piston rod 124 retracts. At the same time, the first check valve 26 is activated by the pressure now present in the first control line 30. The cylinder piston 120 displaces hydraulic fluid from the first piston chamber 116 into the first line arrangement 16. Due to the first throttle device 28, the displaced hydraulic fluid flows out throttled to prevent the cylinder piston 120 from rushing ahead. Since the first check valve 26 is opened, the returning hydraulic fluid can be sucked back in directly via the pump 12. The pressure in the second line arrangement 18 switches the selector valve 38 so that the first line arrangement 16 is connected to the tank 40. Any difference in the volume of hydraulic fluid can thus be sucked back directly from the tank 40 via the first line arrangement 16.

Furthermore, the hydraulic system 10 has a first safety line 42 and a second safety line 44. The first safety line 42 connects the first consumer connection 22 or the first line arrangement 16 and the first piston chamber 116 to the tank 40, and the second safety line 44 connects the second consumer connection 24 or the second line arrangement 18 and the second piston chamber 118 to the tank 40. A pressure relief valve is disposed in each safety line 42, 44, which opens at a safety pressure and relieves the pressure at the respective consumer connection 22, 24 to the tank 40. This prevents damage to the hydraulic unit 110 during operation.

The control unit 20 is configured to operate the motor 12 in the second pressurization mode for a defined time period when switching between the first pressurization mode and the stop mode, and to operate it in the first pressurization mode for a defined time period when switching between the second pressurization mode and the stop mode. The defined time period is in a range between 5 milliseconds and 100 milliseconds, for example 25 milliseconds.

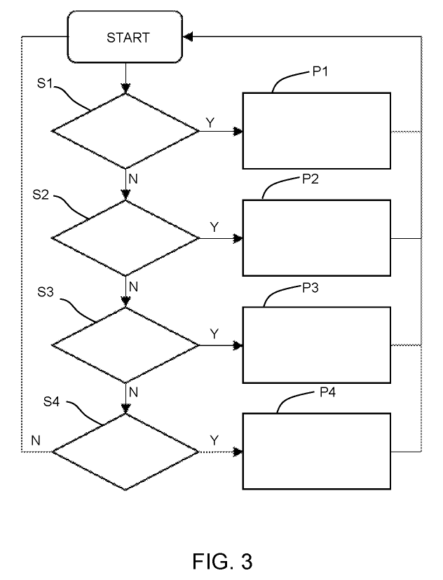

The control sequence of the motor 14 is shown schematically in FIG. 3.

In step S1, the control unit 20 checks whether the motor 14 is in stop mode and should be switched to the first pressurization mode, for example due to a steering command to move the outboard motor 104. If this is the case, the control unit 20 switches motor 14 to the second pressurization mode for the defined time period in accordance with process P1 and only thereafter to the first pressurization mode. This initially causes the first line arrangement 16 to depressurize, as the pressure in the first line arrangement 16 is reduced by pump 12. The subsequent switch to the first pressurization mode pressurizes the first line arrangement 16 via the pump 12. This means that the motor 14 does not run against a relatively high pressure, but against the already relieved pressure in the first line arrangement 16. This allows a higher speed, and thus the full torque, to be achieved before the actual working pressure is required.

If it is determined in step S1 that the motor 14 should not be switched from the stop mode to the first pressurization mode, the control unit checks in step S2 whether the motor 14 should be switched from the stop mode to the second pressurization mode. If this is the case, the control unit 20 switches motor 14 to the first pressurization mode for the defined time period in accordance with process P2 and only thereafter to the second pressurization mode. This relieves the second line arrangement 18, as pump 12 reduces the pressure in the second line arrangement. In the subsequent second pressurization mode, the second line arrangement 18 is pressurized, whereby the motor 14 does not start up against a relatively high pressure, but against the relieved pressure in the second line arrangement 18. This allows a higher speed of the motor 14, and thus the full torque, to be achieved before the actual working pressure is required.

If it is determined in step S2 that the motor 14 should not be switched from the stop mode to the second pressurization mode, the control unit 20 checks in step S3 whether the motor 14 should be switched from the first pressurization mode to the stop mode. If this is the case, the control unit 20 switches the motor 14 directly to the second pressurization mode for the defined time period in accordance with process P3. The short pressure pulse thus generated in the second line arrangement 18 ensures that the second check valve 32 closes securely and does not remain in the open or partially open position due to residual pressure. The motor 14 is then switched to the stop mode by the control unit.

If it is determined in step S3 that the motor 14 should not be switched from the first pressurization mode to the stop mode, the control unit 20 checks in step S4 whether the motor 14 should be switched from the second pressurization mode to the stop mode. If this is the case, the control unit 20 switches motor 14 directly to the first pressurization mode for the defined time period in accordance with process P4. The short pressure pulse thus generated in the first line arrangement 16 ensures that the first check valve 26 closes securely and does not remain in the open or partially open position due to residual pressure.

It should be noted that the sequence of steps S1 to S4 is purely exemplary and can also be changed. Furthermore, steps S1 to S4 can also be performed in parallel.

The defined time period is to be adjusted to the hydraulic system 10 or the hydraulic unit 100 so that it is long enough to achieve the desired effect, but not so long that a jerk or slight movement can be detected at the steering cylinder unit 112. Furthermore, the defined time period does not always have to be identical. It is conceivable that a first defined time period is used when the motor 14 is switched from the first or second pressurization mode to the stop mode, and a second defined time period is used when the motor 14 is switched from the stop mode to the first or second pressurization mode.

Finally, it should be noted that the terms "first" or "second" used in this disclosure do not define a desired order, but merely serve to distinguish the individual elements conceptually. It is therefore also part of this disclosure, for example, that there is a "second" element without a "first" element.

1. A hydraulic system comprising:
a reversible pump,
a motor for driving the pump,
a first line arrangement,
a second line arrangement, and
a control unit,
wherein the first line arrangement is connected to the pump and a first consumer connection, and the second line arrangement is connected to the pump and a second consumer connection,
wherein a first openable check valve is disposed in the first line arrangement,
wherein a second openable check valve is disposed in the second line arrangement,
wherein the control unit is configured to switch the motor between a first pressurization mode, a second pressurization mode, and a stop mode,
wherein the motor drives the pump in a first direction of rotation in the first pressurization mode to pressurize the first line arrangement and in a second direction of rotation in the second pressurization mode to pressurize the second line arrangement,
wherein the control unit is configured to operate the motor in the second pressurization mode for a first defined time period when switching the motor between the first pressurization mode and the stop mode, and
wherein the control unit is configured to operate the motor in the first pressurization mode for a second defined time period when switching between the second pressurization mode and the stop mode.

2. The hydraulic system of claim 1, wherein the first defined time period is at least 5 milliseconds and at most 100 milliseconds.

3. The hydraulic system of claim 1, wherein the second defined time period is at least 5 milliseconds and at most 100 milliseconds.

4. The hydraulic system of claim 1, wherein the control unit is configured to initially drive the motor in the second pressurization mode for the first defined time period when switching from the stop mode to the first pressurization mode, and to initially drive the motor in the first pressurization mode for the second defined time period when switching from the stop mode to the second pressurization mode.

5. The hydraulic system of claim 1, wherein the control unit is configured to drive the motor in the second pressurization mode for the first defined time period when switching from the first pressurization mode to the stop mode, and to drive it in the first pressurization mode for the second defined time period when switching from the second pressurization mode to the stop mode.

6. The hydraulic system of claim 1, wherein the motor is a DC motor.

7. The hydraulic system of claim 1, wherein the motor is a brushless DC motor.

8. The hydraulic system of claim 1, wherein the motor is a DC brush motor.

9. A hydraulic unit for maritime use comprising:
the hydraulic system of claim 1, and
a hydraulic consumer,
wherein the hydraulic consumer is connected to the first consumer connection and the second consumer connection, and wherein the hydraulic unit is a hydraulic unit for trimming, tilting, and/or steering a boat drive.

10. The hydraulic unit of claim 9, wherein the hydraulic unit is a hydraulic unit for trimming a boat drive.

11. The hydraulic unit of claim 9, wherein the hydraulic unit is a hydraulic unit for tilting a boat drive.

12. The hydraulic unit of claim 9, wherein the hydraulic unit is a hydraulic unit for steering a boat drive.

13. A method for operating a hydraulic system of claim 1, the method comprising:
receiving a command to the control unit;
determining, by the control unit and based on the command, if the motor is in stop mode and should be switched to the first pressurization mode;
if the motor should be switched to the first pressurization mode, switching, by the control unit, the motor to the second pressurization mode for the first defined time period; and
switching, by the control unit, the motor to the first pressurization mode after the first defined time period has elapsed.

14. The method of claim 13, further comprising:
if the motor should not be switched to the first pressurization mode, determining, by the control unit and based on the command, if the motor is in stop mode and should be switched to the second pressurization mode;
if the motor should be switched to the second pressurization mode, switching, by the control unit, the motor to the first pressurization mode for the second defined time period; and
switching, by the control unit, the motor to the second pressurization mode after the second defined time period has elapsed.

15. The method of claim 14, further comprising:
if the motor should not be switched to the first pressurization mode or the second pressurization mode, determining, by the control unit and based on the command, if the motor is in the first pressurization mode and should be switched to the stop mode;
if the motor should be switched to the stop mode, switching, by the control unit, the motor to the second pressurization mode for the first defined time period; and
switching, by the control unit, the motor to stop mode after the fist defined time period has elapsed.

16. The method of claim 14, further comprising:
if the motor should not be switched to the first pressurization mode or the second pressurization mode, determining, by the control unit and based on the command, if the motor is in the second pressurization mode and should be switched to the stop mode;
if the motor should be switched to the stop mode, switching, by the control unit, the motor to the first pressurization mode for the second defined time period; and
switching, by the control unit, the motor to stop mode after the second defined time period has elapsed.

17. The method of claim 13, wherein the command is a steering command to move an outboard motor.

18. A method for operating a hydraulic system,
wherein the hydraulic system comprises:
a reversible pump,
a motor for driving the pump,
a first line arrangement, and
a second line arrangement,
wherein the first line arrangement is connected to the pump and a first consumer connection,
wherein the second line arrangement is connected to the pump and a second consumer connection,
wherein a first openable check valve is disposed in the first line arrangement,
wherein a second openable check valve is disposed in the second line arrangement,
wherein the motor drives the pump in a first direction of rotation in the first pressurization mode to pressurize the first line arrangement and in a second direction of rotation in the second pressurization mode to pressurize the second line arrangement, and
wherein the method comprises switching the motor between a first pressurization mode and a stop mode, wherein the motor is driven in a second pressurization mode for a defined time period when switching between the first pressurization mode and the stop mode.

19. The method for operating a hydraulic system of claim 18, wherein the defined time period is at least 5 milliseconds and at most 100 milliseconds.

20. The method for operating a hydraulic system of claim 18, further comprising switching the motor between the second pressurization mode and the stop mode, wherein the motor is initially driven in the second pressurization mode for the defined time period when switching from the first pressurization mode to the stop mode, and the motor is initially driven in the first pressurization mode for the defined time period when switching from the second pressurization mode to the stop mode.
